(19) United States
(12) Patent Application Publication
(10) Pub. No.: US 2025/0052156 A1
(43) Pub. Date: Feb. 13, 2025

(54) CONVERGENCE MONITOR

(71) Applicant: R.J. Goldspink Pty Limited, Mudgee, NSW (AU)

(72) Inventor: Robert Goldspink, Mudgee, NSW (AU)

(21) Appl. No.: 18/718,288

(22) PCT Filed: Dec. 9, 2022
(86) PCT No.: PCT/AU2022/051480

§ 371 Date: Jun. 10, 2024

(30) Foreign Application Priority Data
Dec. 10, 2021 (AU) 2021904005

(51) Int. Cl. E21F 17/18; G01B 3/1061; G01B 3/1071

(52) U.S. Cl. CPC E21F 17/185; G01B 3/1061; G01B 3/1071

(57) ABSTRACT

A device for monitoring convergence between a first surface and a second surface, for example of a mine ceiling and floor, includes a measuring means having a plurality of measurements. The measuring means is attached to a support extending between and in contact with the first surface and the second surface. An indicator body and a release trigger are adapted for mounting in relation to the measuring means.

The indicator body has one or more warning indicators for providing a visual display upon convergence between the first surface and the second surface. The one or more warning indicators are adapted for display in response to activation of the release trigger.

### CROSS-REFERENCE TO RELATED APPLICATIONS

This application is a National Stage application of International Application No. PCT/AU2022/051480 filed on Dec. 9, 2022, which claims priority to Australian Patent Application No. 2021904005 filed on Dec. 10, 2021.

### FIELD

This invention relates to a device for monitoring convergence between a first surface and a second surface. For convenience below, the invention will often be described in connection with monitoring convergence between a first surface being a ceiling of an underground mine and a second surface being a floor of the mine. However, it is to be understood that the present invention is not limited to this application.

### DISCUSSION OF RELATED ART

Underground mines can be unstable. A collapse of a mine ceiling, for example, may have a catastrophic effect: affecting the lives of miners and other personnel in the mine as well as profitability and capital investment.

In developed countries in particular, monitoring is carried out to detect indications of instability, with a view to avoiding catastrophe. In some cases, monitoring may enable a suitable repair or reinforcement of an unstable area. In other cases, monitoring can alert mine personnel in time to vacate the unstable area.

In most cases in the recent past, monitoring has been based on imaging systems to detect convergence or other movement. A popular imaging system is LiDAR (light imaging detection and ranging). Such a system can be accurate and fast in providing images; however, operation is regarded as complex and skilled operators are required. Also, when used in mines there may be interference by mine structures within the required ‘line of sight’ or transmission of signals. The apparatus can be time consuming to set up and is also expensive.

Some of the drawbacks with LiDAR systems can be alleviated by use of drones, but the cost and requirement for skilled operators remain relevant.

There is therefore a need for a simpler, less costly device which is capable of alerting personnel to convergence in a mine, using simple methodology and signals to indicate movement of a ceiling or floor, as examples.

The device of the present invention may alleviate or avoid some or all of the drawbacks referred to above or at least provide a useful alternative.

### SUMMARY

Accordingly, in a first aspect this invention provides a device for monitoring convergence between a first surface and a second surface, the device including:
a measuring means having a plurality of measurements;
means to attach the measuring means to a support extending between and in contact with the first surface and the second surface;
an indicator body adapted for mounting in relation to the measuring means; and
a release trigger adapted for mounting in relation to the measuring means;
wherein the indicator body includes one or more warning indicators for providing a visual display upon convergence between the first surface and the second surface;
and wherein the one or more warning indicators are adapted for display in response to activation of the release trigger.

In a second aspect, the invention provides a combination of a support and a device for monitoring convergence between a first surface and a second surface, the device including:
a measuring means, having a plurality of measurements, attached to the support adapted to extend between and contact with the first surface and the second surface;
an indicator body mounted in relation to the measuring means; and
a release trigger mounted in relation to the measuring means;
wherein the indicator body includes one or more warning indicators for providing a visual display upon convergence between the first surface and the second surface;
and wherein the one or more warning indicators are adapted for display in response to activation of the release trigger.

In a third embodiment, the invention provides a method for monitoring convergence between a first surface and a second surface, the method including the steps:
(i) attaching a measuring means having a plurality of measurements to a support suitable for extending between and in contact with the first surface and the second surface;
(ii) installing the support so that it extends between and in contact with the first surface and the second surface;
(iii) mounting an indicator body in relation to the measuring means, the indicator body having a release trigger and one or more warning indicators for providing a visual display upon convergence between the first surface and the second surface; and
(iv) positioning the release trigger at a selected position in relation to the measuring means;
whereby convergence between the first surface and the second surface is adapted to cause activation of the release trigger followed by display of the one or more warning indicators

In preferred embodiments of the invention one or more of the following features may be used in any relevant combination:

The first and second surfaces to be monitored may be generally vertical or generally horizontal or at an angle of less than 90° to the vertical or horizontal.

The measuring means may be a measuring tape, being marked in small increments of measurements, such as millimetres and/or centimetres. The tape may be generally rigid, but conveniently the tape may be foldable or capable of being coiled, for ease of storage and transport. The measuring means may be protected from debris and damage by a transparent protective film.

The support to which the measuring means is to be attached is preferably a pogo pole or similar support, such as a prop, with sufficient rigidity and length to remain in place between the first and second surfaces in normal conditions.

Preferably, the support has an internal cylinder mounted within an external cylinder, the internal cylinder being spring-biased towards extension. In such an embodiment, one end of the measuring means is preferably attached to the top of the internal cylinder. Convergence of the first surface towards the second surface, or of the second surface towards the first surface, or of mutual convergence, may compress the internal cylinder, resulting in movement of the one end of the measuring means with respect to the second cylinder. This effect is described further below.

A pogo pole is usually lightweight and easy to transport. Traditional props are not lightweight or easy to transport, but the improved props described by the present applicant may be used as a support for the present invention. Some suitable pogo poles and some suitable props are disclosed in PCT Patent Application No. WO 2022246515, the contents of which are incorporated herein by reference.

The support may be height adjustable in any desired way, having regard to the purpose of the device of the invention to detect convergence and display a suitable alert.

The support may have a foot at each end or may have a spike at each end, or a mixture of foot and spike, in order to engage with the first surface and the second surface in an effective manner.

The support may be made of any suitable material, having regard to the requirements of its intended use. There may be restrictions on material: for example, in some jurisdictions a pogo pole or prop assembly intended for use in some types of mining must not be made from aluminium. On the other hand, for transport and handling it is desirable that the assembly of the invention is as light as possible. It is preferred that the support is made principally from steel tubing, preferably powder coated to resist rusting. For mining use, it is preferred that the support is white or light-coloured, optionally with reflective tape, to increase visibility in the typically dark mine environment.

Attachment of the measuring means to the support may vary. In an embodiment where an end of the measuring means is attached to the support at or near the part of the support which is at the first surface, it is preferred that the end of measuring is fixed to a tape retainer, which in turn is removably attached to the support by an O-ring around the circumference of the support and engaged by hooks or similar protrusions. The opposite end of the measuring means may be similarly attached to the support, or may be left free, as required or convenient.

In another embodiment, the end of the measuring means fixed to a tape retainer may be attached to the support using a tooth and pawl type of arrangement, similar to that used in a cable tie.

In yet another embodiment, the attachment may use a clamp similar to a steel hose clamp, of the type having a worm drive for tightening a perforated band.

The indicator body is adapted for mounting in relation to the measuring means. Preferably, the indicator body is suitable secured to the support. In one embodiment, one or more O-rings may be used for this purpose. As an example, each such O-ring may be arranged around the circumference of the support and engaged by hooks or similar protrusions. Preferably, such hooks or protrusions are part of the indicator body.

A tooth and pawl type of arrangement is one alternate method of attaching the indicator body to the support.

In a preferred embodiment, the measuring means is threaded through the indicator body as part of assembly of the device on the support. The indicator body may include one or more indicator arrows or some other type of indication intended to show a starting measurement at zero or some other chosen measurement. This starting measurement can be used to indicate the extent of convergence.

The release trigger is mounted in relation to the measuring means. This may be achieved by having the release trigger mounted on a sleeve threaded onto the measuring means. Preferably, the release trigger includes a locking tab for locking the release trigger in position on the measuring means within the indicator body, so that the starting measurement is set and locked.

Ideally, the indicator body is mounted with respect to the measuring means at approximately average eye height, for convenient inspection of any degree of convergence, which may be indicated by display of a measurement different from the starting measurement.

The indicator body may be made of any suitable material or combination of materials. One example is molded plastic of sufficient thickness to provide the necessary robustness. Other materials or combinations of material may be used.

The indicator body includes one or more warning indicators for providing a visual display upon convergence between the first surface and the second surface. While the warning indicator or indicators may take any convenient form, in a preferred embodiment each indicator is a type of flag. Preferably, each warning indicator has a bright red colour, the surface being reflective for easy detection.

Optionally, the indicator body may include one or more ‘safe mode’ indicators for providing a visual display that no relevant convergence has taken place since installation—or last resetting—of the device of the invention. In a preferred embodiment each ‘safe mode’ indicator is a type of flag. Preferably, each ‘safe mode’ indicator has a bright green colour, the surface being reflective for easy detection. The invention is not limited to these options.

In the embodiment where the indicator body may include one or more ‘safe mode’ indicators for providing a visual display that no relevant convergence has taken place, it is preferred that in the default mode of the device of the invention displays the one or more ‘safe mode’ indicators and that these are replaced by the one or more warning indicators once a pre-set amount of convergence has taken place. For this purpose, the indicator body may include appropriate slits through which the ‘safe mode’ or ‘warning’ indicator may be displayed.

The release trigger may be activated as described in the following non-limiting embodiment: when convergence occurs between the first and second surfaces, the measuring means is forced to slide through the indicator body, taking with it the release trigger. If the release trigger reaches the location of the indicator arrows, the release trigger engages a release ramp, a warning indicator release catch is freed and each warning indicator is activated. Any ‘safe mode’ indicator is retracted at the same time. Once the release ramp has been traversed by the release trigger, the warning indicator release catch is held back until the device is reset. If the amount of convergence is such that the measuring means continues to slide through the indicator body, the indicator arrows will show the total movement between the first and second surfaces.

The device of the invention may be reset as appropriate, each warning indicator being retracted into the indicator body and each ‘safe mode’ indicator displayed. The device of the invention may have a testing mechanism, for ensuring that it is operating as intended. For example, a button when pressed may activate the warning indicator. The device can then be reset as described above.

### BRIEF DESCRIPTION OF THE DRAWINGS

The invention may be better understood from the following non-limiting description of preferred embodiments, in which:

FIG. 1 is an elevation of an embodiment of the device of the invention, combined with a support of variable length;

FIG. 2 shows an enlarged view of the upper part of the combination of FIG. 1;

FIG. 3 shows an enlarged view of an embodiment of the indicator body combined with the support shown in FIG. 1, having ‘safe mode’ indicators;

FIG. 4 is a side view of the indicator body and support shown in FIG. 1;

FIG. 5 is a front elevation of the indicator body and support shown in FIG. 1 having warning indicators;

FIGS. 6, 7 and 8 are cross-sections of the indicator body of FIG. 1, FIG. 6 showing the indicator body at original set-up, FIG. 7 showing activation of the warning indicator and FIG. 8 showing configuration of the device indicating total movement;

FIG. 9 illustrates a variation of the upper part of the combination of FIG. 1; and

FIGS. 10, 11 and 12 show different views of a variation of attachment of the indicator body to the support.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

It will be appreciated that not all the drawings have the same scale.

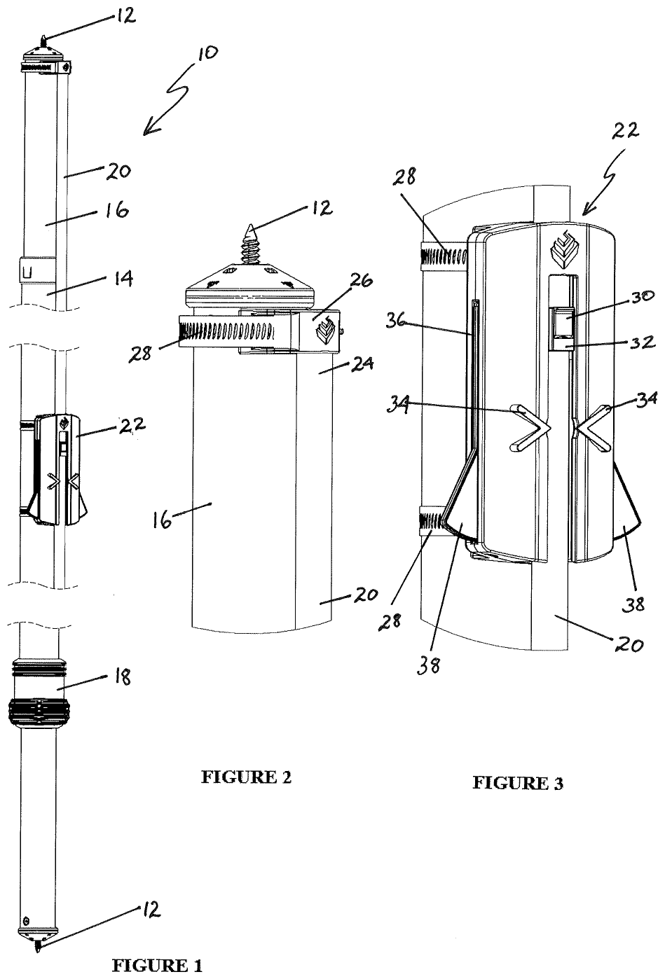

Reference is first made to FIGS. 1 and 2. Pogo pole 10 is indicated as being of indeterminate length, since polo pole 10 may be supplied in various length to cater for different customer requirements. Pole 10 has upper and lower spikes 12, to enable pole 10 to be secured to a first surface and a second surface in a secure manner. Instead of spikes 12, feet (not shown) may be used.

Pole 10 has main cylinder 14 and concentric cylinder 16, which is movable axially within cylinder 14, being spring biased upwardly. Pole 10 also has a quick release collet mechanism 18, which enables pole 10 to be disengaged quickly if it is desired to move pole 10 away from an installed location where upper spike 12 is secured in a ceiling and lower spike 12 is secured in a ground. Pole 10 may be pulled downwardly and collet 18 rotated, to release collet 18. Lower spike 12 may be removed from the ground and pole 10 released from engagement with the ceiling.

As FIG. 1 shows, measuring tape 20 made of flexible steel is attached to pole 10 at an upper end of spring biased cylinder 16. The lower end of tape 20 is not shown in FIG. 1, but it does not extend as far as collet 18. Indicator body 22 is attached to pole 10 about halfway. In situ, the location of indicator body 22 may be adjusted so that it is approximately at eye level.

FIG. 2 shows the upper end 24 of measuring tape 20 attached to the upper end of cylinder 16. In FIGS. 1, 2 and 3 the plurality of measurements has been omitted from tape 20 for simplicity. Upper tape end 24 is captured in top tape retainer 26 which in turn is attached to cylinder 16 by pawl and teeth tie 28.

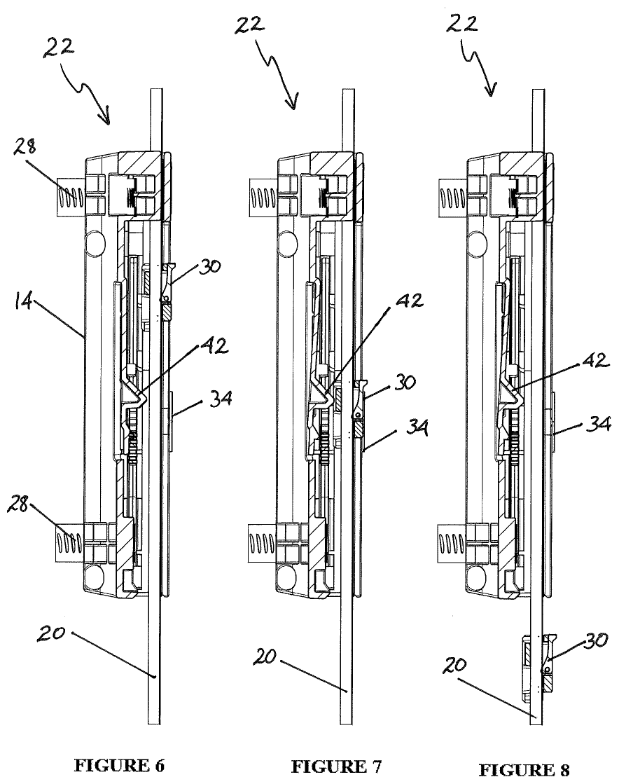

As seen in FIG. 3, indicator body 22 is attached to pole 10 by two pawl and teeth ties 28. Tape 20 is fed through indicator body 22 and locked in place by release trigger 30 which includes locking tab 32. Release trigger 30 is threaded onto tape 22 from the lower end (not shown) of tape 22. This configuration corresponds to that in FIG. 6—the setup or reset position. Indicator body 22 has opposing indicator arrows 34 which are used to show the amount of convergence that has occurred since the device of the invention was last checked (further details below).

Indicator body 22 has an elongated slot 36 on each side (only one is visible in FIG. 3). These slots enable indicators to be retracted into or displayed from indicator body 22. In FIG. 3, ‘safe mode’ indicators 38 are protruding from slots 36. In this embodiment, ‘safe mode’ indicators 38 are green, being reflective.

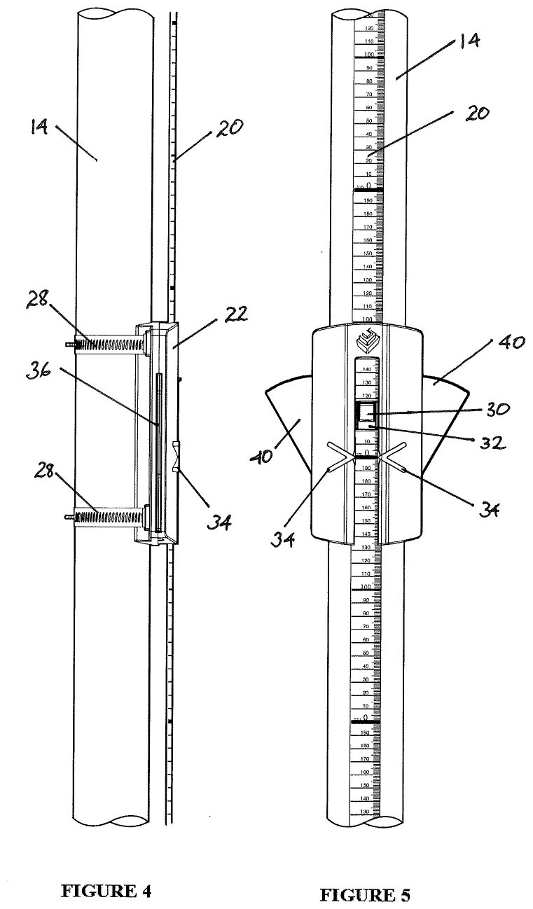

FIG. 4 is a side view of the combination in FIG. 3 and FIG. 5 is a front elevation. There are two changes. First, the plurality of measurements is shown in FIGS. 4 and 5. In this embodiment, tape 20 is marked with repetitions of measurements from zero to 200 mm. FIG. 5 shows indicator arrows 34 locked on ‘zero’ on tape measure 20, locking tab 32 on release trigger 30 holding tape 20 in that position until movement of the ceiling pushes cylinder 16 and tape 20 downward. The second difference is that in FIG. 5 red warning indicators 40 have been activated, ‘safe mode’ indicators 38 (green) having been retracted.

FIGS. 6, 7 and 8 are side sectional views of indicator body 22, showing progression during convergence of ceiling and floor.

In FIG. 6, indicator body 22 and release trigger 30 are in the setup or reset position. Release trigger 30 is two to three centimetres above indicator arrows 34. In this position, ‘safe mode’ indicators 38 are displayed, as seen in FIG. 3.

In FIG. 7, there has been some movement of the ceiling. Cylinder 16 has been pressed downwardly, against the spring bias, tape 20 and release trigger 30 have been forced to travel downwardly, through indicator body 22. When release trigger 30 has reached indicator arrows 34, warning indicator release catch 42 is freed and red warning indicators 40 spring outwardly, as in FIG. 5.

In FIG. 8, movement of the ceiling has continued, tape 20 has continued its downwards path, release trigger 30 has travelled through indicator body 22 and is now below indicator body 22. Reading tape 20 will show the extent of movement that has occurred. Red warning indicators 40 remain on display.

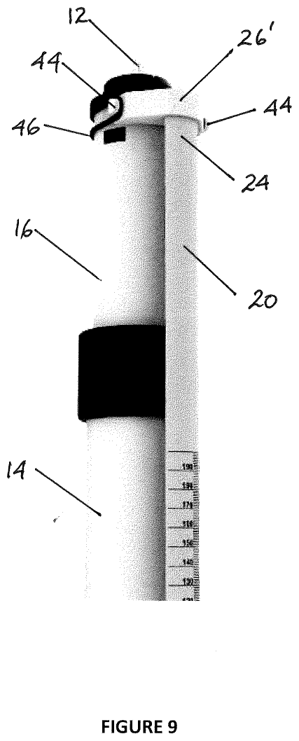

FIG. 9 shows a variation of the combined pole and device. In contrast to FIG. 2, FIG. 9 shows the upper end 24 of measuring tape 20 captured in top tape retainer 26′ which in this embodiment has a pair of hooks 44. O-ring 46 is hooked around both hooks 44 to attach top tape retainer 26′ to cylinder 16.

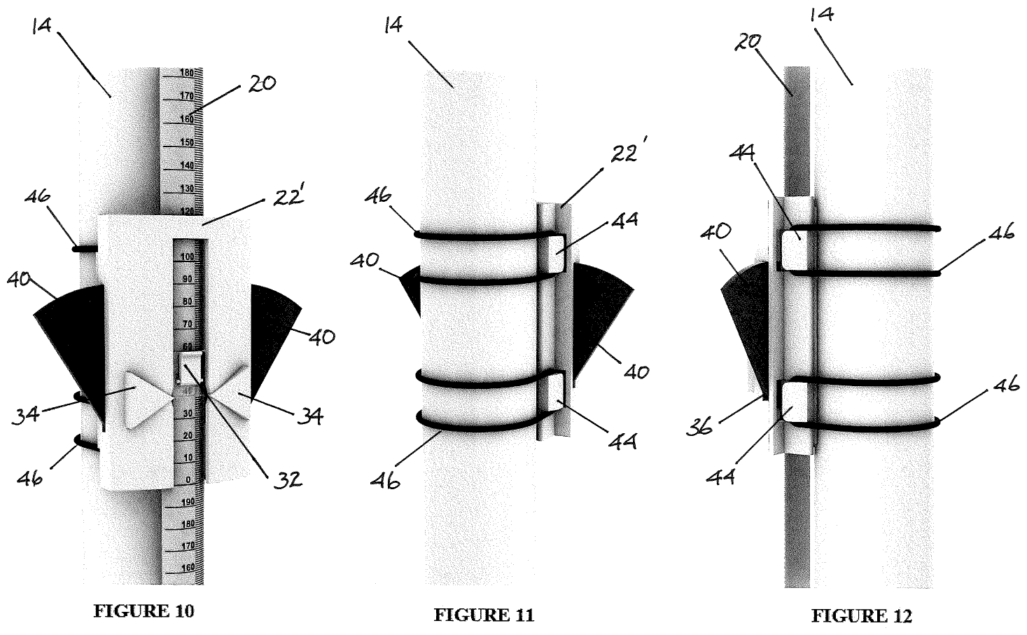

Similarly, in FIGS. 10, 11 and 12, indicator body 22′ has two pairs of hooks 44. An O-ring 46 is hooked around each hook in a horizontal pair of hooks, to attach indicator body 22′ to pole 10.

FIGS. 10 to 12 also show how red warning indicators 40, when displayed, are visible through 360°.

Installation of a pole 10 and the device of the invention is particularly simple and fast. In this illustration, pole 10 is provide separately from a kit containing parts of the device. The attachment mode is that in FIGS. 9 to 12.

First, measuring tape 20, presented in the kit as thin steel rolled into a coil, is released and permitted to unravel to a straight configuration. End 24 is inserted into top tape retainer 26′, where tape end 24 can lock into place.

Three O-rings are in the kit, one being smaller than the other two. The smaller O-ring 46 is used to attach top tape retainer 26′ to the highest point of pole 10, by hooking O-ring 46 around both hooks 44 as seen in FIG. 9.

Pogo pole 10 is next installed in the desired position for monitoring, leaving as much as possible of cylinder 16 uncompressed.

Indicator body 22′ is slid onto the lower (free) end of measuring tape 20 and positioned so that indicator arrows 34 line up with the zero mark on measuring tape 20. The zero mark may be red in colour for easy identification. It is preferred that indicator arrows 34 are at about eye level. Indicator body 22′ is then secured in place using the two larger O-rings and hooks 44, as illustrated in 11 and 12.

Release trigger 30 is slid onto the lower end of measuring tape 20, with locking tab 32 open, and pushed upwardly until indicator arrows 34 are in the desired release position, such in the range 0 to 50 mm. Locking tab 32 is the closed to lock release trigger 30 in position.

During installation, red warning indicators 40 will go on display as release trigger 30 passes indicator arrows 34 and these must be reset to the closed position, with ‘safe mode’ indicators on display.

If a record tag is attached to a ring (not shown) on the indicator body, the installation details are completed. The record tag is retained in place for long-term monitoring.

The embodiments described above relates to preferred embodiments of the present invention only and are given by way of illustration. Changes, modifications and variations may be made without departing from the spirit and scope of the present invention.

### INDUSTRIAL APPLICABILITY

It will be appreciated that the invention in its various embodiments represents a significant advance in the art, providing an inexpensive monitoring device that does not require image detection or transmission while being fast and simple to install and disassemble.

1. A device for monitoring convergence between a first surface and a second surface, the device including:
a measuring means having a plurality of measurements;
means to attach the measuring means to a support extending between and in contact with the first surface and the second surface;
an indicator body adapted for mounting in relation to the measuring means; and
a release trigger adapted for mounting in relation to the measuring means;
wherein the indicator body includes one or more warning indicators for providing a visual display upon convergence between the first surface and the second surface;
and wherein the one or more warning indicators are adapted for display in response to activation of the release trigger.

2. The device of claim 1, wherein the support has a foot or a spike at each end, in order to engage with the first surface and the second surface in an effective manner.

3. The device of claim 2, wherein the support has a foot at one end and a spike at the other end.

4. The device of claim 1, wherein an end of the measuring means is attached to the support at or near the part of the support which is at the first surface.

5. The device of claim 4, wherein the end of measuring means attached to the support is fixed to a tape retainer.

6. The device of claim 5, wherein the tape retainer is removably attached to the support by one or more O-rings around the support.

7. The device of claim 6, wherein each O-ring is engaged by hooks on the tape retainer.

8. The device of claim 5, wherein the tape retainer is attached to the support using a tooth and pawl arrangement.

9. The device of claim 5, wherein the tape retainer is attached to the support using a clamp having a worm drive for tightening a perforated band.

10. The device of claim 1, wherein the measuring means is threaded through the indicator body.

11. The device of claim 10, wherein the indicator body includes one or more indicator means for indicating a starting measurement of zero or some other chosen measurement, for indicating an extent of convergence.

12. The device of claim 1, wherein the release trigger is mounted on a sleeve threaded onto the measuring means.

13. The device of claim 12, wherein the release trigger includes a locking tab for locking the release trigger in position on the measuring means within the indicator body, so that the starting measurement is set and locked.

14. The device of claim 1, wherein the or each warning indicator is a type of flag.

15. The device of claim 14, wherein the or each warning indicator has a bright red colour and a reflective surface.

16. The device of claim 1, wherein the indicator body includes one or more ‘safe mode’ indicators for providing a visual display that no relevant convergence has taken place since installation or most recent resetting of the device of the invention.

17. The device of claim 16, wherein the or each ‘safe mode’ indicator is a type of flag.

18. The device of claim 17, wherein the or each ‘safe mode’ indicator has a bright green colour and a reflective surface.

19. The device of claim 1, when combined with the support.

20. A method for monitoring convergence between a first surface and a second surface, the method including the steps:
(i) attaching a measuring means having a plurality of measurements to a support suitable for extending between and in contact with the first surface and the second surface;
(ii) installing the support so that it extends between and in contact with the first surface and the second surface;
(iii) mounting an indicator body in relation to the measuring means, the indicator body having a release trigger and one or more warning indicators for providing a visual display upon convergence between the first surface and the second surface; and
(iv) positioning the release trigger at a selected position in relation to the measuring means;
whereby convergence between the first surface and the second surface is adapted to cause activation of the release trigger followed by display of the one or more warning indicators.
